(19) United States
(12) Patent Application Publication
(10) Pub. No.: US 2018/0157635 A1
(43) Pub. Date: Jun. 7, 2018

(54) METHOD FOR CHECKING SPELLINGS AND GRAMMARS OF TEXT DOCUMENT

(71) Applicant: Lianhui ZHOU, Zhangjiagang, Jiangsu (CN)

(72) Inventor: Lianhui ZHOU, Zhangjiagang, Jiangsu (CN)

(21) Appl. No.: 15/735,168

(22) PCT Filed: Jun. 15, 2015
(86) PCT No.: PCT/CN2015/000414

§ 371 Date: Dec. 9, 2017

(30) Foreign Application Priority Data
Jun. 11, 2015 (CN) 201510319466.2

(51) Int. Cl. G06F 17/27; G06F 17/24

(52) U.S. Cl. CPC G06F 17/273; G06F 17/24; G06F 17/2735; G06F 17/274

(57) ABSTRACT

One Method for Checking Spellings and Grammars of Text Document is provided with the following beneficial effects: the text and document spelling and grammar proofreading method of the invention displays the “lines” with spelling and grammatical mistakes in a centralized manner to facilitate the users' checking and processing. These “lines” will be restored after users complete checking, and then replace the original “lines”; spelling and grammar check efficiency will be greatly improved, especially for longer text and document.

### TECHNICAL FIELD

The invention specifically relates to Method for Checking Spellings and Grammars of Text Document, which falls into the technical field of computer information processing.

### BACKGROUND TECHNOLOGY

When writing articles, people often use office software, such as Microsoft Word 2013. In a Word 2013 document, users often see red, blue, or green wavy lines beneath certain words or phrases. This is a word or phrase containing spelling or grammatical mistakes indicated by the Word 2013 dictionary through the “Spelling and Grammar” checker tool provided in Word 2013. The red and blue wavy lines indicate words or phrases which contain spelling mistakes, while the green wavy lines indicate grammatical mistakes. Users can check spelling and grammar mistakes in Word documents using the “Spelling and Grammar” checker tool in Word 2013 document by following these steps:

first step, open the Word 2013 document window, if you see the Word document contains a red, blue or green wavy line, indicating that the Word document has spelling or grammatical mistakes. Switch to the “Review” ribbon, click the “Spelling and Grammar” button in the “Proofreading”, and click the “Spelling and Grammar” button.

second step, open the “Spellcheck” task pane, and confirm if there are indeed spelling or grammatical mistakes in the words or phrases marked according to spelling check prompt in the task pane. If there is indeed a mistake, then click the “Change” button as prompted. If there are no mistakes in the words or phrases you have identified, users can click the “Ignore” or “Ignore All” to ignore the suggestions for changes to this word or phrase. Users can also click the “Add” button, and add the marked words or phrases to Word 2013 built-in dictionary.

third step, after completing the spelling and grammar check, directly turn off “Spellcheck” task pane. This proofreading function greatly improves office productivity, enabling users to discover English word spelling and grammatical mistakes in the text in time. For short text, such as a few pages, users can use this function to find out in a relatively short period of time whether there are spelling or grammatical mistakes in the identified words or sentences. According to these prompts, users can make corresponding changes. However, for writers, editors, secretaries and other groups, it is commonplace to deal with texts longer than a hundred pages in length, and using such software is somewhat cumbersome and inefficient. Because most spelling and grammar mistakes do not appear evenly on every page, they are randomly distributed in each sentence; for example, users may not find mistakes on consecutive pages, but suddenly find a large number of mistakes on the pages after 30. Even so, users also need to consecutively examine each page of the text to avoid missing spelling and grammatical mistakes that the spelling and grammar checker tool hasn't identified.

When proofread Chinese, domestically launched Dark Horse Proofreading Software adopted a method which is to “view and handle by using the next or previous” command to locate the cursor on the wrong entry, use “modify” suggestion order to view the modifying suggestions to the wrong entries given by Dark Horse, and directly correct the error entries; after the end of the amendment, users can finally clear all the marked in color by Dark Horse. In addition to word, text, PDF and other forms of text, users can realize the proofreading of Chinese, and there is no substantive difference compared to proofreading English.

It can be seen from this that the prior art generally has the disadvantage of being inefficient for text and document spelling and grammar checking

### Content of the Invention

Therefore, the invention is directed to the disadvantage of the prior art that is generally inefficient for text and document spelling and grammar checking. The invention provides a text and document spelling and grammar proofreading method, which is realized through this text and document spelling and grammar proofreading system. The proofreading system comprises text and document reading unit, dictionary unit, spelling and grammar checking unit, marking and sorting unit, document processing interface, and operation interface. This method concludes the following steps:

Step 1: Check and Mark

Users use the text and document reading unit of text and document spelling and grammar proofreading system, open the to-be-checked document, and select the spelling and grammar check options to the operation interface. The system automatically compares the entire content of the text with the content of the dictionary unit. And the marking and sorting unit marks the spelling and grammatical mistakes, at the same time, marks and numbers “lines” in the text that contains spelling and grammatical mistakes;

Step 2: Process Together

The system arranges and displays all the lines with spelling and grammatical mistakes sequentially, and users can deal with the spelling and grammatical mistakes on the document processing interface;

Step 3: Restore the Text and Document Arrangement

After processing the spelling and grammatical mistakes, users select the option “restore text and document arrangement” on the operation interface, the “lines” that the marking and sorting unit has processed will replace the original “lines” and re-arrange the layout according to the marked in step 1.

Wherein, the marking and sorting unit in step 1 marks the lines in the text and document that contain spelling and grammatical mistakes as underlined red.

Wherein, in the step 2, the system arranges all the “lines” with spelling and grammatical mistakes in the forefront of the text and document.

Wherein, in the step 2, the system arranges all the “lines” with spelling and grammatical mistakes according to the order of numbers in step 1 or according to the preset priorities.

Wherein, in the step 2, when users process the spelling and grammatical mistakes on the document processing interface, the options include spelling suggestions, ignoring, ignoring all, adding to the dictionary, and automatic correcting.

The invention has the following beneficial effects; the text and document spelling and grammar proofreading method of the invention displays the “lines” with spelling and grammatical mistakes in a centralized manner to facilitate the users' checking and processing. These “lines” will he restored after users complete checking, and then replace the original “lines”. Spelling and grammar check efficiency will be greatly improved, especially for longer text and document. The invention can also arrange the “lines” with mistakes based on preset rules, making the users convenient to choose priorities of processing the spelling and grammatical mistakes.

### DESCRIPTION OF FIGURES

FIG. 1, FIG. 2 and FIG. 3 are flowcharts of the text and document spelling and grammar proofreading method of the invention.

### SPECIFIC METHOD OF PRACTICE

The specific practice method of the invention is described below with reference to the accompanying drawings:

Through the text and document spelling and grammar proofreadiug system to realize, the proofreading system includes text: and document reading unit, dictionary unit, spelling and grammar checking unit, marking and sorting unit, document processing interface and operation interface.

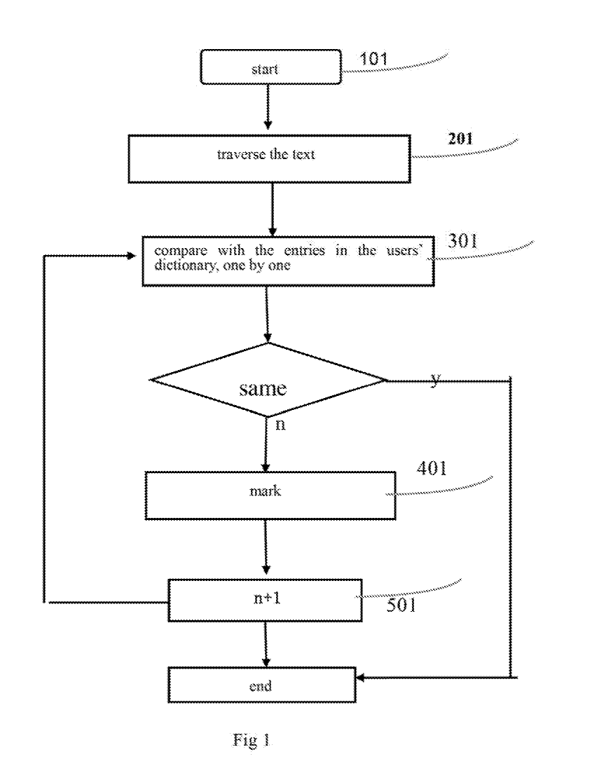

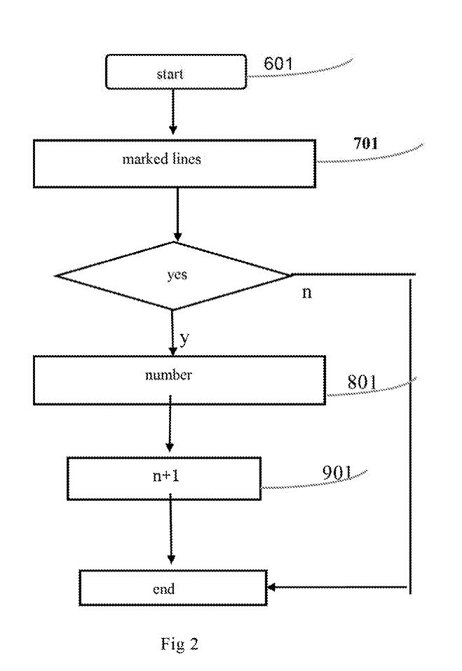

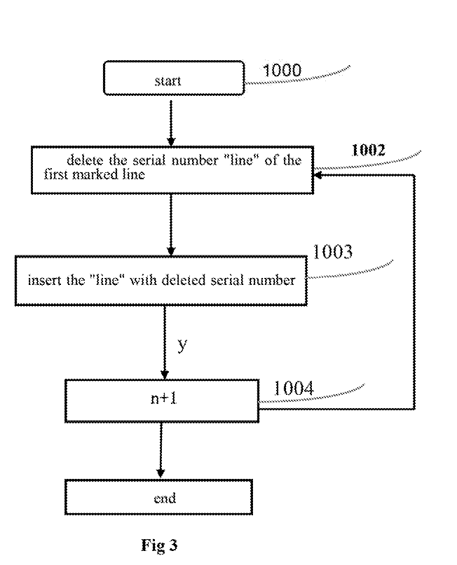

A text and document spelling and grammar proofreading method, whose process is shown in FIG. 1:

Step 1: Check and Mark

Users use the text and document reading unit of text and document spelling and grammar proofreading system, open the to-be-checked document, and select the spelling and grammar check options in the operation interface. The system automatically compares the entire content of the text with the content of the dictionary unit. And the marking and sorting unit marks the spelling and grammatical mistakes, at the same time, marks and numbers “lines” in the text that contains spelling and grammatical mistakes;

Step 2: Process Together

The system arranges and displays all the lines with spelling and grammatical mistakes sequentially, and users can deal with the spelling and grammatical mistakes on the document processing interface;

Step 3: Restore the Text and Document Arrangement

After processing the spelling and grammatical mistakes, users select the option “restore text and document. arrangement” on the operation interface, the “lines” that the marking and sorting unit has processed will replace the original “lines” and re-arrange the layout according to the marked in step 1.

As a preferable method, the marking and sorting unit in step 1 marks the lines in the text and document that contain spelling and grammatical mistakes as underlined red, easier to identify clearly and in line with people's reading habits.

As a preferable method, in the step 2, the system arranges all the “lines” with spelling and grammatical mistakes in the forefront of the text and document. It is more convenient to process directly.

As a preferable method, in the step 2, the system arranges all the “lines” with spelling and grammatical mistakes according to the order of numbers in step 1 or according to the preset priorities. If users prioritize the processing sequence according to the mistakes, such as the input error or special usage, misused quantifier and other priority order, users can preferentially select the important mistakes for processing.

As a preferable method, in the step 2, when users process the spelling and grammatical mistakes on the document processing interface, the options include spelling suggestions, ignoring, ignoring all, adding to the dictionary, and automatic correcting. Users can also manually modify and add to the dictionary.

The main procedure of the text and document spelling and grammar proofreading system is as follows:

```
101 start
201 traverse the text
301 compare with the entries in the users' dictionary, one by one
different same-
    |
mark
    |
next one
401 end
501 start
601 marked lines
  Y
701 number n
801 n+1
901 end
    |
1000 start
1001 delete the serial number “line” of the first marked line
1002 insert the “line” with deleted serial number to the original location
1003 n+1 ---
1004 end
```

The above description is the preferred implementation of the present invention, and it should he noted that for the common technicians in the technology can make various improvements and modifications without departing from the principle of the present invention. Such improvements and modifications should also be regarded as the protection scope of the present invention.

1. One method for Checking Spellings and Grammars of Text Document, characterized in that, the method comprises the following steps:
Step 1: Check and Mark
Users use the text and document reading unit of text and document spelling and grammar proofreading system, open the to-be-checked document, and select the spelling and grammar check options in the operation interface. The system automatically compares the entire content of the text with the content of the dictionary unit. And the marking and sorting unit marks the spelling and grammatical mistakes, at the same time, marks and numbers “lines” in the text that contains spelling and grammatical mistakes;
Step 2: Process Together
The system arranges and displays all the lines with spelling and grammatical mistakes sequentially, and users can deal with the spelling and grammatical mistakes on the document processing interface;
Step 3: Restore the Text and Document Arrangement
After processing the spelling and grammatical mistakes, users select the option “restore text and document arrangement” on the operation interface, the “lines” that the marking and sorting unit has processed will replace the original “lines” and re-arrange the layout according to the marked in step 1.

2. According to claim 1, Method for Checking Spellings and Grammars or Text Document, characterized in that, the marking and sorting unit in step 1 marks the lines in the text and document that contain spelling and grammatical mistakes as underlined red.

3. According to claim 1, Method for Checking Spellings and Grammars of Text Document, characterized in that, in the step 2, the system arranges all the “lines” with spelling and grammatical mistakes in the forefront of the text and document.

4. According to claim 1, Method for Checking Spellings and Grammars of Text Document, characterized in that, in the step 2, the system arranges all the “lines” with spelling and grammatical mistakes according to the order of numbers in step 1 or according to the preset priorities.

5. According to claim 1, Method for Checking Spellings and Grammars of Text Document, characterized in that, in the step 2, when users process the spelling and grammatical mistakes on the document processing interface, the options include: spelling suggestions, ignoring, ignoring all, adding to the dictionary, and automatic correcting.
